(19) United States
(12) Patent Application Publication
(10) Pub. No.: US 2025/0218692 A1
(43) Pub. Date: Jul. 3, 2025

(54) CAPACITOR COMPONENT

(71) Applicant: SAMSUNG ELECTRO-MECHANICS CO., LTD., Suwon-si (KR)

(72) Inventors: Won Su SON, Suwon-si (KR); Ki Pyo HONG, Suwon-si (KR)

(73) Assignee: SAMSUNG ELECTRO-MECHANICS CO., LTD., Suwon-si (KR)

(21) Appl. No.: 18/971,874

(22) Filed: Dec. 6, 2024

(30) Foreign Application Priority Data
Dec. 29, 2023 (KR) 10-2023-0196231

(51) Int. Cl. H01G 4/32; H01G 4/012; H01G 4/12; H01G 4/232

(52) U.S. Cl. CPC H01G 4/32; H01G 4/012; H01G 4/1227; H01G 4/232

(57) ABSTRACT

A capacitor component comprises a body that includes a dielectric layer and first and second internal electrodes alternately disposed with the dielectric layer interposed between them. The internal electrodes and dielectric layer are wound around an axis which extends in a second direction. The component further includes external electrodes disposed on opposing third and fourth surfaces of the body in the second direction. The body also has a first surface and a second surface opposing each other in a first direction, which is perpendicular to the second direction, and a fifth surface and a sixth surface opposing each other in a third direction, perpendicular to both the first and second directions.

### CROSS-REFERENCE TO RELATED APPLICATION(S)

This application claims benefit of priority to Korean Patent Application No. 10-2023-0196231 filed on Dec. 29, 2023 in the Korean Intellectual Property Office, the disclosure of which is incorporated herein by reference in its entirety.

### TECHNICAL FIELD

The present disclosure relates to a capacitor component.

A multilayer ceramic capacitor (MLCC), a multilayer electronic component, is an important chip component used in industries such as communications, computers, home appliances, and automobiles due to its advantages of being small in size and offering high capacitance. In particular, it is a key passive element used in various electric, electronic and information communication devices such as mobile phones, computers, and digital TVs.

Since multilayer ceramic capacitors have advantages such as small size, high capacitance, ease of mounting, and more, multilayer ceramic capacitors may be used as components in various electronic devices. Recently, multilayer ceramic capacitors have become smaller and have been implemented with higher capacitance due to the miniaturization and high performance of electronic devices.

Meanwhile, multilayer ceramic capacitors are formed by stacking a plurality of internal electrodes and first dielectric green sheets. When an MLCC having this structure operates in a high temperature and high voltage environment, cracks may occur due to shrinkage and expansion (electrostriction) of a dielectric layer due to piezoelectricity. In particular, cracks may form between the internal electrodes and dielectric insufficient in adhesive strength, which may cause an MLCC failure. In addition, conventional multilayer ceramic capacitors may have a step difference in a margin portion depending on variations in the stacking degree of the internal electrodes.

Therefore, a new structure and manufacturing method for a capacitor component that can suppress the electrostriction and step differences while maintaining capacitance per unit volume achieved in existing multilayer ceramic capacitors is needed.

### SUMMARY

An aspect of the present disclosure is to reduce the occurrence of cracks in a capacitor component by suppressing expansion and contraction due to electrostriction.

Another aspect of the present disclosure is to alleviate a step difference due to a difference in the degree of stacking of internal electrodes.

Another aspect of the present disclosure is to improve productivity of capacitor components.

However, the purpose of the present disclosure is not limited to the above-described contents and will be more easily understood in the process of explaining specific exemplary embodiments of the present disclosure.

According to an aspect of the present disclosure, a capacitor component includes: a body including a dielectric layer and first and second internal electrodes alternately disposed with the dielectric layer interposed therebetween and wound around an axis which extends in a second direction; and external electrodes respectively disposed on third and fourth surfaces of the body opposing each other in the second direction, wherein the body further includes a first surface and a second surface opposing each other in a first direction, perpendicular to the second direction, and a fifth surface and a sixth surface opposing each other in a third direction, perpendicular to the first and second directions.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a capacitor component according to an exemplary embodiment in the present disclosure;

FIG. 2 is a schematic perspective view of a body according to an exemplary embodiment in the present disclosure;

FIG. 3 is a cross-sectional view taken along line I-I of FIG. 1;

FIG. 4 is a cross-sectional view taken along line II-II of FIG. 1;

FIG. 5 is a schematic perspective view of a sheet forming an internal electrode and a dielectric layer of a capacitor component according to an exemplary embodiment;

FIG. 6 is a schematic perspective view of a process in which a sheet forming an internal electrode and a dielectric layer is wound around an axis which extends in a second direction in a capacitor component according to an exemplary embodiment;

FIG. 7 is a cross-sectional view corresponding to the II-II′ cross-section of FIG. 1 in a capacitor component according to an exemplary embodiment;

FIG. 8 is a schematic perspective view of a sheet forming an internal electrode and a dielectric layer in a capacitor component according to an exemplary embodiment; and

FIG. 9 is a cross-sectional view corresponding to the II-II′ cross-section of FIG. 1 in a capacitor component according to an exemplary embodiment.

### DETAILED DESCRIPTION

Hereinafter, exemplary embodiments of the present inventive concept will be described in detail with reference to the accompanying drawings. The inventive concept may, however, be exemplified in many different forms and should not be construed as being limited to the specific exemplary embodiments set forth herein. Rather, these exemplary embodiments are provided to ensure this disclosure is thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrelevant to the description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

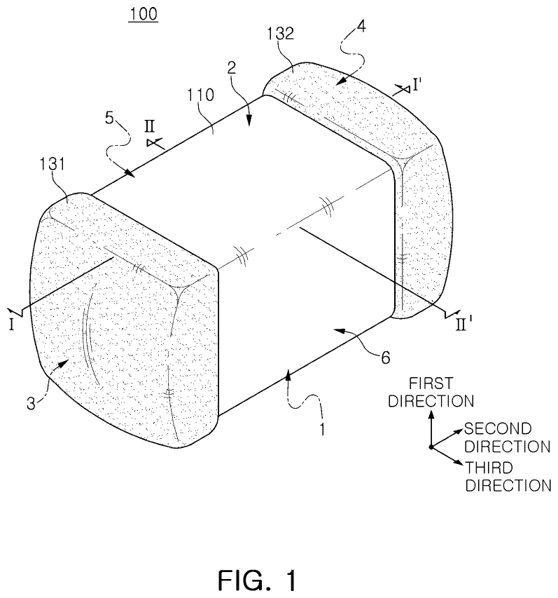

FIG. 1 is a schematic perspective view of a capacitor component according to an exemplary embodiment in the present disclosure.

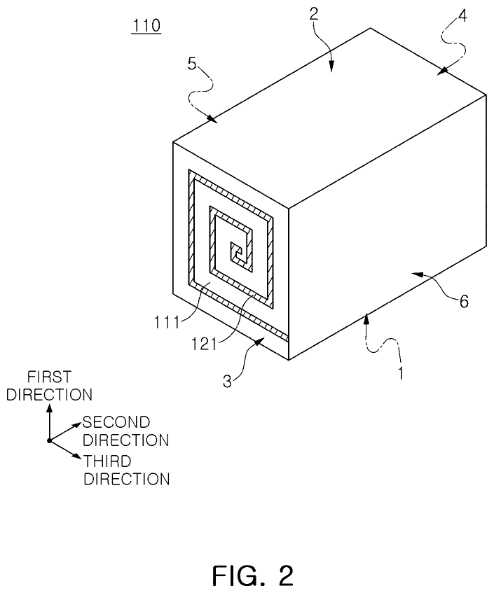

FIG. 2 is a schematic perspective view of a body according to an exemplary embodiment in the present disclosure.

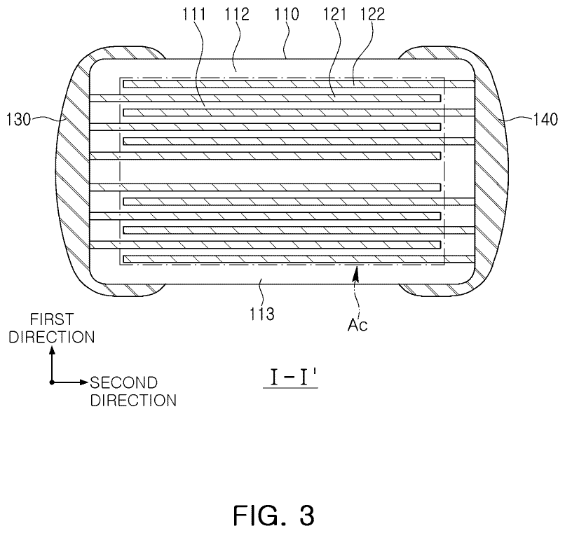

FIG. 3 is a cross-sectional view taken along line I-I of FIG. 1.

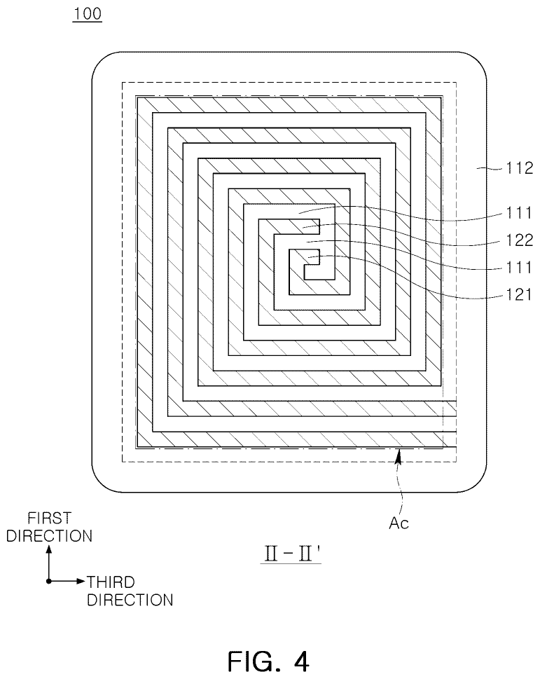

FIG. 4 is a cross-sectional view taken along line II-II of FIG. 1.

Hereinafter, a capacitor component 100 according to an exemplary embodiment of the present disclosure will be described with reference to FIGS. 1 to 4.

A capacitor component 100 according to an exemplary embodiment in the present disclosure includes a body 110 including a dielectric layer 111 and first and second internal electrodes 121 and 122 alternately disposed with the dielectric layer interposed therebetween and wound around an axis which extends in the second direction and external electrodes 131 and 132 respectively disposed on a third surface 3 and a fourth surface 4 of the body opposing each other in the second direction, wherein the body may further include a first surface 1 and a second surface 2 opposing each other in a first direction, perpendicular to the second direction, and a fifth surface 5 and a sixth surface 6 opposing each other in a third direction, perpendicular to the first and second directions.

The body 110 may comprise the dielectric layer 111 and the first and second internal electrodes 121 and 122 alternately disposed with the dielectric layer interposed between them and wound around an axis which extends in the second direction.

There is no particular limitation on the specific shape of the body 110, but as illustrated, the body 110 may be formed in a substantially hexahedral shape or a similar shape. Due to the shrinkage of ceramic powder included in the body 110 during a sintering process, the body 110 may not be perfectly flat, but instead may adopt a substantially hexahedral shape. Specifically, the body 110 may comprise the third surface 3 and the fourth surface 4 opposing each other in the second direction, the first surface 1 and the second surface 2 opposing each other in the first direction, perpendicular to the second direction, and the fifth surface 5 and the sixth surface 6 opposing each other in the third direction, perpendicular to the first and second directions.

Referring to FIGS. 2 and 3, the third surface 3 may be in contact with the first internal electrode 121 and may be spaced apart from the fourth surface 4, while the fourth surface 4 may be in contact with the second internal electrode 122 and may be spaced apart from the third surface 3. Through this, different polarities may be applied to the first internal electrode 121 and the second internal electrode 122.

The dielectric layer 111 forming the body 110 is in a sintered state, and adjacent dielectric layers 111 may be integrated such that boundaries between them may not be readily apparent without using a scanning electron microscope (SEM).

The dielectric layer 111 may be formed by manufacturing a ceramic slurry comprising ceramic powder, an organic solvent, and a binder, applying and drying the slurry on a carrier film to prepare a ceramic green sheet, and then sintering the ceramic green sheet. The ceramic powder is not particularly limited as long as it may provide sufficient capacitance, but, for example, barium titanate-based (BaTiO₃) powder may be used as the ceramic powder. For a more specific example, the ceramic powder may be barium titanate-based (BaTiO₃) powder, for example, one or more of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1). In this case, the dielectric layer 111 may include Ba and Ti.

An average thickness td of the dielectric layer 111 is not particularly limited.

In order to achieve miniaturization and high capacitance of the capacitor component 100, the average thickness td of the dielectric layer 111 may be 1.0 μm or less, and in order to improve the reliability of the capacitor component 100 under high temperature and high voltage, the average thickness td of the dielectric layer 111 may be 3 μm or more.

The first and second internal electrodes 121 and 122 may be wound around an axis which extends in the second direction, and the dielectric layer 111 may be disposed between the first and second internal electrodes 121 and 122.

A material forming the first and second internal electrodes 121 and 122 is not particularly limited and may include a conductive metal with excellent electrical conductivity. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

Meanwhile, the first and second internal electrodes 121 and 122 may include the same conductive metal, but are not limited to this, and may include different conductive metals.

In addition, the first internal electrode 121 may contact the external electrode 131 at one end of the body 110 in the second direction, and the second internal electrode 122 may contact the external electrode 132 at the other end of the body 110 in the second direction.

The external electrodes 131 and 132 are disposed on the third surface 3 and the fourth surface 4 of the body 110 and are connected to the internal electrodes 121 and 122. Specifically, the first external electrode 131 is disposed on the third surface 3 and connected to the first internal electrode 121, while the second external electrode 132 is disposed on the fourth surface 4 and connected to the second internal electrode 122.

In the present exemplary embodiment, although a structure in which the capacitor component 100 has two external electrodes 131 and 132 is described, the number or shape of the external electrodes 131 and 132 may be changed depending on the shape of the internal electrode 121 and 122 or other purposes.

Meanwhile, the external electrodes 131 and 132 may be formed using any electrically conductive material, such as metal, and a specific material may be selected based on electrical characteristics, structural stability, etc.

Additionally, the external electrodes 131 and 132 may be formed as a single layer or multiple layers and may include an electrode layer directly contacting each of the first and second surfaces 1 and 2 and a plating layer disposed on the electrode layer. However, without being limited thereto, a conductive resin layer comprising a thermosetting resin and a conductive metal may be disposed between the electrode layer and the plating layer.

The related art multilayer ceramic capacitor includes a body formed by alternately stacking dielectric layers and internal electrodes. When voltage is applied to a terminal electrode of the multilayer ceramic capacitor, shrinkage and expansion of the dielectric layer, which includes a piezoelectric material may occur, which applies stress to the entire multilayer ceramic capacitor.

Additionally, when using the multilayer ceramic capacitor in a high-voltage environment, the magnitude of the stress due to the electrostriction may increase further, potentially causing cracks to occur between the internal electrodes and the dielectric layer with insufficient adhesive strength.

The body 110 of the capacitor component 100, according to an exemplary embodiment in the present disclosure may include the dielectric layer 111 and the first and second internal electrodes 121 and 122, which are alternately disposed with the dielectric layer interposed therebetween and wound around an axis which extends in the second direction.

Accordingly, by minimizing a difference in shrinkage behavior of the body 110 in the first or third direction, the occurrence of cracks in the capacitor component 100 may be suppressed.

Meanwhile, in the related art wound-type capacitor, the body is formed by winding a plurality of dielectric and internal electrode sheets, resulting in a substantially cylindrical structure. The wound-type capacitor having such a cylindrical structure has a small effective volume when mounted on a substrate, etc., and thus may have problems, such as reduced reliability in securing effective capacitance.

Accordingly, in an exemplary embodiment of the present disclosure, the body 110 may further include the first surface 1 and the second surface 2 opposing each other in the first direction, perpendicular to the second direction, and the fifth surface 5 and the sixth surface 6 opposing each other in the third direction, perpendicular to the first and second directions, thereby improving the effective volume, which may be more advantageous in securing effective capacitance.

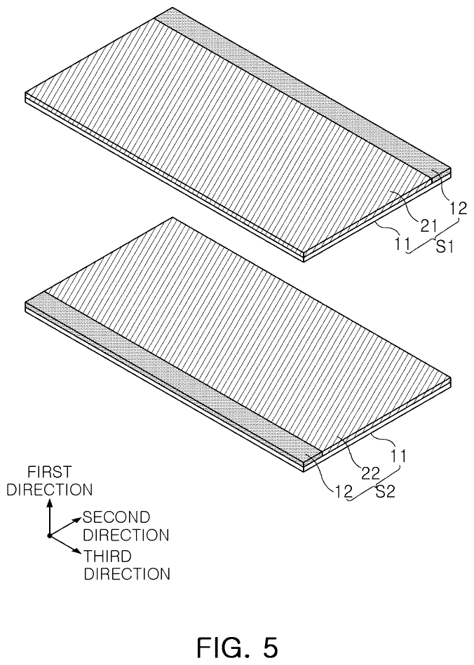

FIG. 5 schematically illustrates a perspective view of a sheet forming an internal electrode and a dielectric layer of the capacitor component 100, according to an exemplary embodiment.

In FIG. 5, a first sheet S1 may include a first dielectric green sheet 11 and a first internal electrode pattern 21 disposed on the first dielectric green sheet 11, while a second sheet S2 may include the first dielectric green sheet 11 and a second internal electrode pattern 22 disposed on the first dielectric green sheet 11. At this time, the first internal electrode pattern 21 and the second internal electrode pattern 22 may be disposed offset in the second direction. The first dielectric green sheet 11 may be sintered to become the dielectric layer 111, the first internal electrode pattern 21 may be sintered to become the first internal electrode 121, and the second internal electrode pattern 22 may be sintered to become the second internal electrode 122.

The first sheet S1 and the second sheet S2 may be stacked in the first direction and then rolled with the second direction as an axis. A winding direction is not particularly limited as long as the second direction is the axis.

Meanwhile, in an exemplary embodiment in the present disclosure, the body 110 may have a substantially hexahedral shape. A method of forming the body 110 to have a substantially hexahedral shape is not particularly limited. For example, when the first sheet S1 and the second sheet S2 are wound around an axis which extends in the second direction, the first sheet S1 and the second sheet S2 may be wound using a square pillar-shaped shaft, or a method of forming a cylindrical roll body formed by winding the first sheet S1 and the second sheet S2 into a cylindrical shape and then processing the same to have a hexahedral shape using a hexahedral mold.

Meanwhile, the second dielectric green sheet 12 may be disposed in a region in which the first internal electrode pattern 21 on the first dielectric green sheet 11 of the first sheet S1 is not disposed, and the second dielectric green sheet 12 may be disposed in a region in which the second internal electrode pattern 22 on the first dielectric green sheet 11 of the second sheet S2 is not disposed. Accordingly, when the first sheet S1 and the second sheet S2 are wound around an axis which extends in the second direction, misalignment or a step difference between the sheets may be prevented.

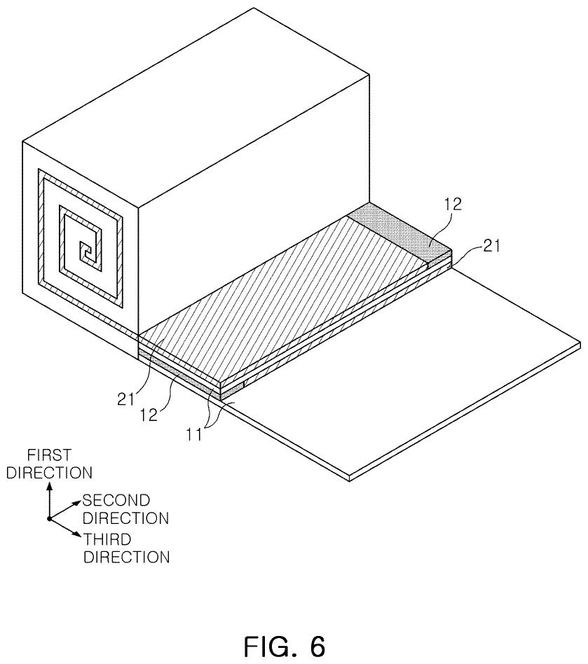

FIG. 6 is a perspective view schematically illustrating a process in which a sheet forming an internal electrode and a dielectric layer is wound around an axis which extends in the second direction in a capacitor component 100′ according to an exemplary embodiment.

Referring to FIG. 6, the first sheet S1 and the second sheet S2 may be wound around an axis which extends in the second direction to form a roll body. The roll body may become the body 110 after compression or firing.

In an exemplary embodiment, the first dielectric green sheet 11 included in the second sheet S2 may be longer in the third direction than the first dielectric green sheet 11, the first internal electrode pattern 21, and the second internal electrode pattern 22 included in the first sheet S1. Accordingly, the end portion of the first dielectric green sheet 11 included in the second sheet S2 in the third direction may be formed as a protective layer 112 of the body 110.

In an exemplary embodiment, the body 110 may include a capacitance formation portion Ac in which a capacitance is formed, including a region in which the first and second internal electrodes 121 and 122 are wound around an axis which extends in the second direction, and a protective layer 112 disposed on the capacitance formation portion Ac.

The protective layer 112 may play a role in improving the mechanical strength and moisture resistance of the capacitor component 100.

Meanwhile, in order to secure moisture resistance reliability of the capacitor component 100, the protective layer 112 may cover the ends of the first and second internal electrodes 121 and 122.

Components of the protective layer 112 are not particularly limited but may include components having excellent mechanical strength, moisture resistance, and excellent insulation.

Meanwhile, in the manufacturing process of the capacitor component 100, the dielectric layer 111 and the protective layer 112 may be formed integrally. That is, in an exemplary embodiment, the protective layer 112 may be in contact with the end portion of the dielectric layer 111. In addition, the protective layer 112 may include the same material as a dielectric material included in the dielectric layer 111.

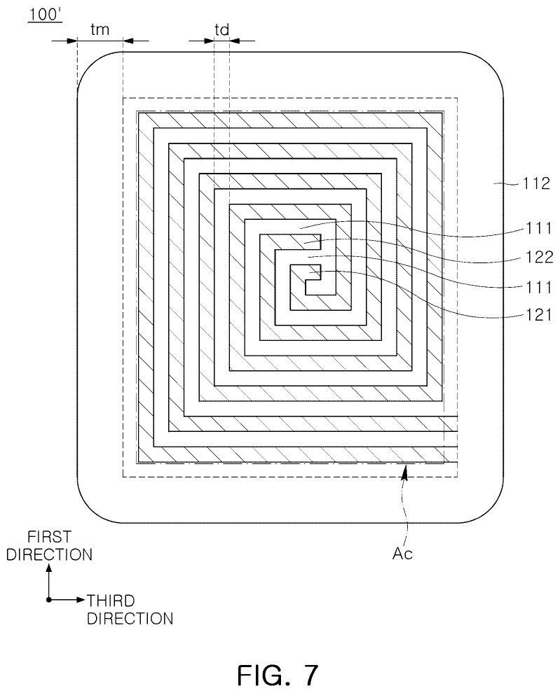

Referring to FIG. 7, the protective layer 112 may be formed to have a thickness thicker than the dielectric layer 111. That is, in an exemplary embodiment, an average thickness tm of the protective layer 112 may be greater than the average thickness td of the dielectric layer 111. Accordingly, the moisture resistance reliability of the capacitor component 100′ may be further improved. A method for forming the protective layer 112 to have the average thickness tm greater than the average thickness td of the dielectric layer 111 is not particularly limited, but as shown in FIG. 6, the first dielectric green sheet 11 included in the second sheet S2 may be formed to be longer than the first dielectric green sheet 11, the first internal electrode pattern 21, and the second internal electrode pattern 22 included in the first sheet S1 by the circumference or larger of the body 110.

A method for measuring the average thickness tm of the protective layer 112 and the average thickness td of the dielectric layer 111 is not particularly limited. For example, the average thickness td of the dielectric layer 111 may refer to an average value of a width of the dielectric layer in the third direction measured at a center point of the capacitance formation portion Ac in the first direction and the third direction, two equally spaced points on the left in the third direction and two equally spaced points on the right based on the center point of the capacitance formation portion Ac in the first direction and the third direction in a cross-section in the first direction and the third direction polished to the center portion of the capacitor component 100 in the second direction. In addition, the average thickness of the protective layer 112 may refer to an average value of a width in the third direction measured at a center point of the protective layer in the first direction, two equally spaced points on the left in the third direction and two equally spaced points on the right in the protective layer formed on the side surface of the capacitance formation portion Ac in the third direction. However, the average thickness tm of the protective layer 112 and the average thickness td of the dielectric layer 111 may not only refer to the size of the width in the third direction, but may also refer to a thickness in the first direction.

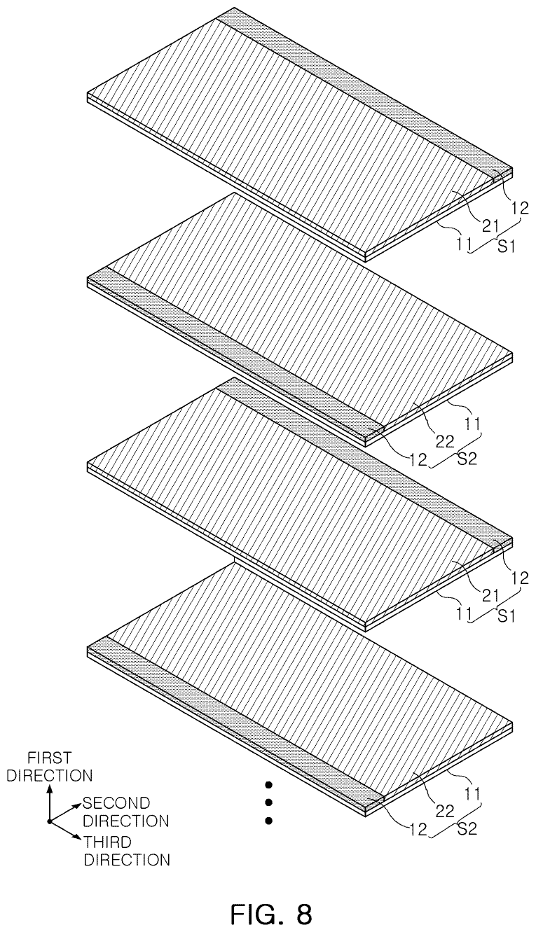

FIG. 8 is a perspective view schematically illustrating a sheet forming an internal electrode and a dielectric layer of a capacitor component 100″ according to an exemplary embodiment.

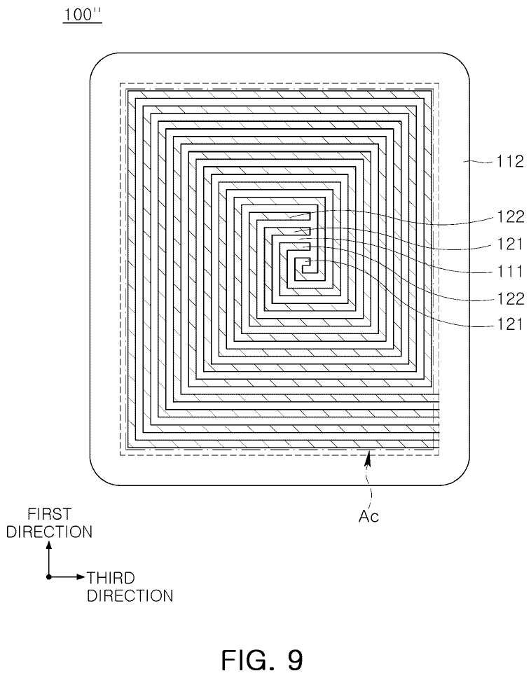

FIG. 9 is a cross-sectional view corresponding to the II-II′ cross-section of FIG. 1 in a capacitor component according to an exemplary embodiment.

Referring to FIG. 8, a body of the capacitor component 100″ according to an exemplary embodiment may be formed by stacking two or more layers of the first sheet S1 and the second sheet S2 and winding the same in the second direction. Accordingly, the productivity of the capacitor component 100″ may be improved.

Referring to FIG. 8, the first sheet S1 and the second sheet S2 are each stacked in two or more layers and wound around an axis which extends in the second direction, so that the body 110 may include two or more layers of first internal electrodes 121 arranged to be spaced apart from each other in the first and third directions and the second internal electrodes 122 arranged to be spaced apart from each other in the first and third directions.

Among the various effects of the present disclosure, the capacitor component includes the first and second internal electrodes alternately disposed with the dielectric layer interposed therebetween and wound around an axis which extends in the second direction, thereby suppressing the occurrence of non-uniform shrinkage behavior in the capacitor component.

One of the various effects of the present disclosure is to suppress a step difference caused by the formation of a margin portion by eliminating differences in the degree of stacking of the internal electrodes of the capacitor component.

While exemplary embodiments have been shown and described above, it will be apparent to those skilled in the art that modifications and variations may be made without departing from the scope of the present disclosure as defined by the appended claims.

What is claimed is:

1. A capacitor component comprising:
a body including a dielectric layer and first and second internal electrodes, the first and second internal electrodes being alternately disposed with the dielectric layer interposed therebetween and wound around an axis which extends in a second direction; and
external electrodes respectively disposed on third and fourth surfaces of the body opposing each other in the second direction,
wherein the body further includes a first surface and a second surface opposing each other in a first direction, the first direction being perpendicular to the second direction, and a fifth surface and a sixth surface opposing each other in a third direction, the third direction being perpendicular to the first and second directions.

2. The capacitor component of claim 1, wherein the body has a substantially hexahedral shape.

3. The capacitor component of claim 1, wherein the dielectric layer comprises barium (Ba) and titanium (Ti).

4. The capacitor component of claim 1, wherein the first internal electrode is in contact with a first external electrode at one end of the body in the second direction, and the second internal electrode is in contact with a second external electrode at the opposite end of the body in the second direction.

5. The capacitor component of claim 1, wherein the body includes a capacitance formation portion in which capacitance is formed, comprising a region in which the first and second internal electrodes are wound around the axis which extends in the second direction, and a protective layer disposed on the capacitance formation portion.

6. The capacitor component of claim 5, wherein an average thickness of the protective layer is greater than an average thickness of the dielectric layer.

7. The capacitor component of claim 5, wherein the protective layer extends to cover ends of the first and second internal electrodes.

8. The capacitor component of claim 5, wherein the protective layer includes the same dielectric material as the dielectric layer.

9. The capacitor component of claim 5, wherein the protective layer is in contact with an end portion of the dielectric layer.

10. The capacitor component of claim 1, wherein the first and second internal electrodes, each wound around the axis which extends in the second direction, form a single layer.

11. The capacitor component of claim 1, wherein the body includes two or more layers of first internal electrodes, each spaced apart from one another in both the first and third directions and two or more layers of second internal electrodes, each spaced apart from one another in both the first and third directions.

12. A capacitor component comprising:
a body including a dielectric layer and first and second internal electrodes alternately disposed with the dielectric layer interposed therebetween, the first and second internal electrodes being wound around an axis which extends in a second direction;
external electrodes respectively disposed on third and fourth surfaces of the body opposing each other in the second direction;
a protective layer disposed on a capacitance formation portion of the body, the capacitance formation portion comprising a region where the first and second internal electrodes are wound around the axis which extends in the second direction.

13. The capacitor component of claim 12, wherein the protective layer is configured to cover the ends of the first and second internal electrodes and is in contact with an end portion of the dielectric layer, the protective layer being formed of the same dielectric material as the dielectric layer.

14. The capacitor component of claim 12, wherein the protective layer has an average thickness greater than the average thickness of the dielectric layer.
